(19) United States
(12) Patent Application Publication
(10) Pub. No.: US 2006/0257831 A1
(43) Pub. Date: Nov. 16, 2006

(54) Typing game apparatus

(75) Inventor: Kazuo Okada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/404,120

(22) Filed: Apr. 14, 2006

(30) Foreign Application Priority Data
Apr. 19, 2005 (JP) 2005-121124

(51) Int. Cl. G09B 13/00; A63F 13/00

(52) U.S. Cl. 434/227; 463/1

(57) ABSTRACT

The invention relates to a typing game apparatus on which is executed a typing game in which a character string displayed on a display is input, and more particularly to a typing game apparatus on which even a typing game beginner can fully enjoy the typing game. On a typing game apparatus, when a key arranged on a keyboard is depressed to input one character included in one phrase of lyrics displayed in a lyrics display portion and a roman letter display portion, a determination of the correctness of the key input and its timing is performed in a correctness determination process. At this point, in the case of erroneous input operations in which keys different from those of determination reference data have been depressed, and in the case where the number of the erroneous input operations is smaller than or equal to the number of admissible characters indicated by number-of-admissible-characters data which is stored in a ROM, the erroneous input operations are deemed to be correct key inputs as their determination result, thereby proceeding with a typing game.

### RELATED APPLICATION

This application claims the priority of Japanese Patent Application No. 2005-121124 filed on Apr. 19, 2005, which is incorporated herein by reference.

### BACKGROUND OF THE INVENTION

1. Technical Field

The present invention relates to a typing game apparatus on which is executed a typing game in which a character string displayed on a display is input, and more particularly to a typing game apparatus on which even a typing game beginner can fully enjoy the typing game.

2. Related Art

Currently, among games performed at a game center, on a home video apparatus, and so on, a typing game, which progresses as a character string displayed on a display is input from a keyboard, has gained popularity. In such a typing game, it is often the case that a character string is input from a keyboard within a predetermined time period, and when the key input does not match the character string displayed on a display, it follows that the game is discontinued (e.g., see Patent Document: Japanese Unexamined Patent Publication No. 2002-268534).

On the other hand, currently, along with increasingly advanced computerization, personal computers and word processors have become widespread, and documentation using a keyboard has also been widely performed. Accordingly, as chances to make character inputs with the keyboard are thus increasing, it would not be an exaggeration to say that many people have experienced the inputting with the keyboard.

However, in the documentation using the keyboard, unlike the aforementioned typing game, the restriction that prescribed characters must be input within a predetermined time period is not imposed thereon, and basically, a document is created by carrying out additions and alterations at creator's own pace.

In other words, in the case of character inputs under special circumstances such as imposing the aforementioned time restriction, the characters cannot be input within the predetermined time period, or too much worry about the predetermined time period leads to frequent input errors. In other words, no one can fully enjoy the entertainment provided in the typing game unless he/she is a person fully skilled in inputting characters with the keyboard. That is, it follows that players who can fully enjoy the entertainment provided by the typing game are limited to a small and limited proportion, and many other players cannot fully enjoy playing the typing game.

As a result thereof, a typing game beginner, who is unskilled at typing games, cannot fully enjoy playing the typing game, and stays away from the typing game, thus resulting in a reduction in the number of players.

In the aforementioned Patent Document, a typing game in which lyrics of a song are input along with a reproduction of the song is described. In the typing game described in the Patent Document, a technology is disclosed which is configured such that, by reducing the reproduction tempo of the song, more time for receiving key input operations is given to the typing game beginner who is unskilled at typing games, so that even the typing game beginner can enjoy the typing game.

Furthermore, in the typing game described in the Patent Document, it is disclosed that the game result of the previous typing game (the number of errors, the kind of erroneously depressed keys, and the like) is analyzed, and a song is automatically selected in accordance with the analysis result. It follows thereby that a song matching the skill of a player is selected, so that even the typing game beginner can enjoy the typing game.

### SUMMARY OF THE INVENTION

The invention relates to a typing game apparatus on which is executed a typing game in which a character string displayed on a display is input, and while bearing in mind the aforementioned problem, from a different viewpoint from that of the aforementioned Patent Document, an object of the invention is to provide a typing game apparatus on which even a typing game beginner can fully enjoy the typing game.

According to the invention of claim 1, which has been made to achieve this object, a typing game apparatus (e.g., a typing game apparatus 1) comprises: a display (e.g., a first liquid crystal display 3) which displays a character; an input device (e.g., a keyboard 6) having arranged thereon a plurality of keys corresponding to a plurality of the characters; a storing device (e.g., a ROM 53, a RAM 54, an HDD 55) which stores determination reference data for use in determining the correctness of the result of an input from the input device; a correctness determination module (e.g., a CPU 51) which determines the correctness of a key input based on the result of the input from the input device and the determination reference data; a game controller (e.g., the CPU 51) which proceeds with a typing game based on the determination result of the correctness determination module; a number-of-erroneous-inputs counter (e.g., the CPU 51) which, when inputs have been made with different keys from the ones indicated by characters displayed on the display, counts the number of the inputs as erroneous input operations; and an admissible character determination module (e.g., the CPU 51) which, when the result of the count by the number-of-erroneous-inputs counter satisfies an admissibility condition that erroneous key inputs be deemed correct, determines the erroneous input operations to be correct key inputs as their input result.

Also, according to the invention of claim 2, in a typing game apparatus (e.g., the typing game apparatus 1) according to claim 1, the admissibility condition is a condition which, when erroneous input operations have been performed in which inputs are made with different keys from the ones indicated by characters displayed on the display, specifies the number of the inputs which are deemed to be correct key inputs.

Furthermore, according to the invention of claim 3, in a typing game apparatus (e.g., the typing game apparatus 1) according to claim 1 or 2, the storing device (e.g., the ROM 53, the RAM 54, the HDD 55) stores song data related to a song, the determination reference data includes input determination reference data, which is used to determine the correctness of key inputs which are based on lyrics of the song, and timing determination reference data, which is used to determine the correctness of the timing of the key inputs, and the game controller (e.g., the CPU 51) proceeds with the typing game based on the song data.

According to the typing game apparatus of claim 1, when erroneous input operations have been performed in which inputs have been made with different keys from the ones indicated by characters displayed on the display, the number-of-erroneous-inputs counter counts the number of the erroneous input operations. Then, based on the count result and the admissibility condition, the admissible character determination module determines whether or not the erroneous input operations are deemed to be correct key inputs.

Accordingly, as long as key input operations are continued until the admissibility condition is satisfied, any key input is determined to be a correct key input, so that even a beginner who is unskilled at typing games can perform key operations without worrying about erroneous inputs. Also, the typing game is executed with an erroneous input deemed to be a correct input, so that even the typing game beginner can fully enjoy the typing game.

According to the typing game apparatus of claim 2, in the typing game apparatus according to claim 1, the admissibility condition is set as a condition which, when erroneous input operations have been performed in which inputs are made with different keys from the ones indicated by characters displayed on the display, specifies the number of the inputs which are deemed to be correct key inputs. Accordingly, as long as even the typing game beginner continues key input operations until the number of erroneous input operations reaches the number specified by the admissibility condition, any key input is determined to be a correct key input. Accordingly, even the typing game beginner can perform key operations without worrying about erroneous inputs, and can thus fully enjoy the typing game.

According to the typing game apparatus of claim 3, the typing game is executed based on the song data stored in the storing device. At this point, the correctness determination module determines the correctness of key inputs and input timings, based on the determination reference data which includes the input determination reference data and the timing determination reference data, and the typing game progresses based on the result of the correctness determination. That is, even in the case of a typing game which requires a higher-level key input operation such as lyrics of a song being input at a predetermined timing as the song is played, as long as key input operations are continued until the admissibility condition is satisfied, any key input is determined to be a correct key input. Accordingly, even a beginner who is unskilled at typing games can perform key operations without worrying about erroneous inputs. Also, the typing game is executed with an erroneous input deemed to be a correct input, so that even the typing game beginner can fully enjoy the typing game.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

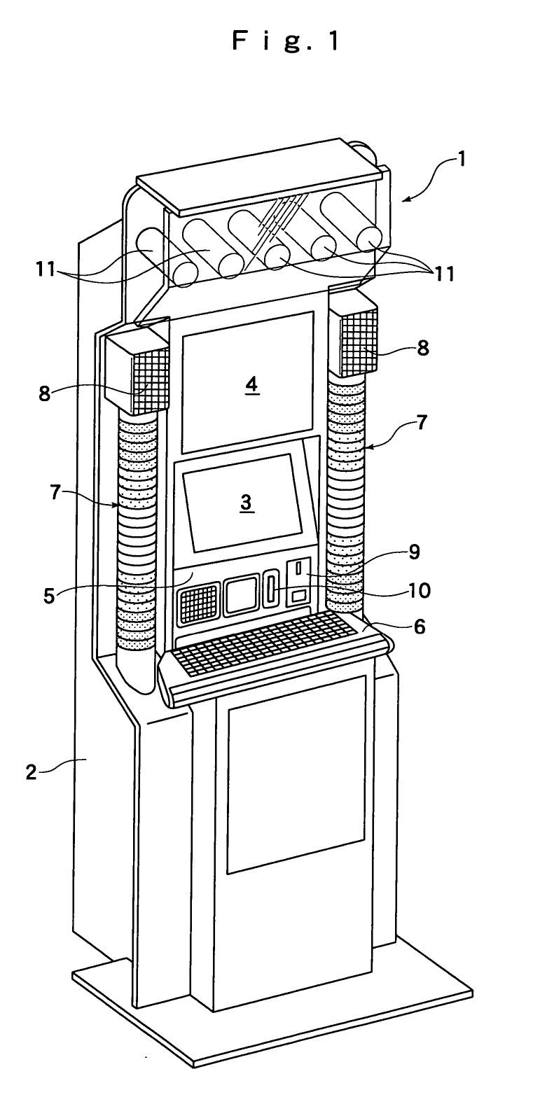

FIG. 1 is a perspective view of a typing game apparatus according to an embodiment;

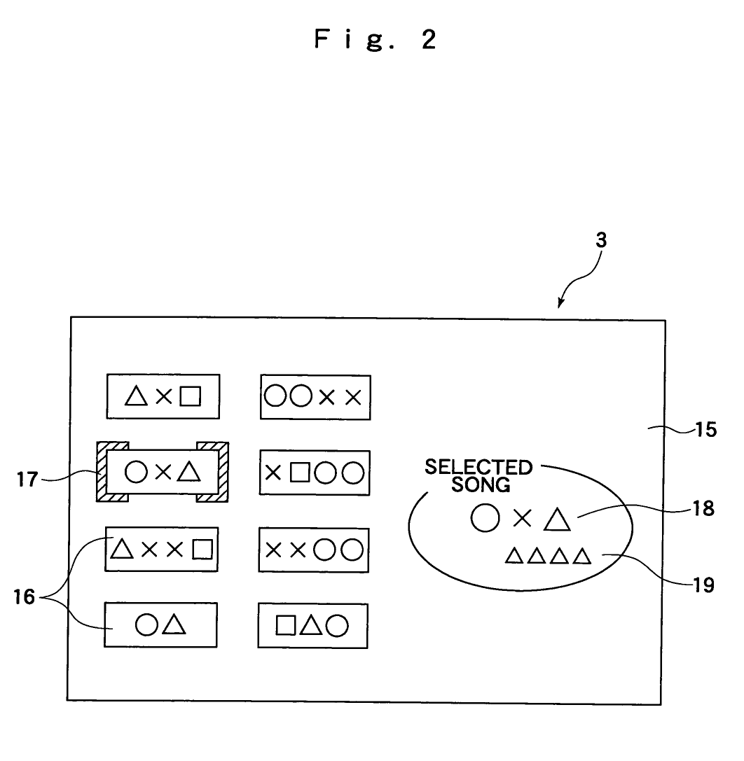

FIG. 2 is a pattern diagram showing a display content displayed on a first liquid crystal display before the start of a typing game;

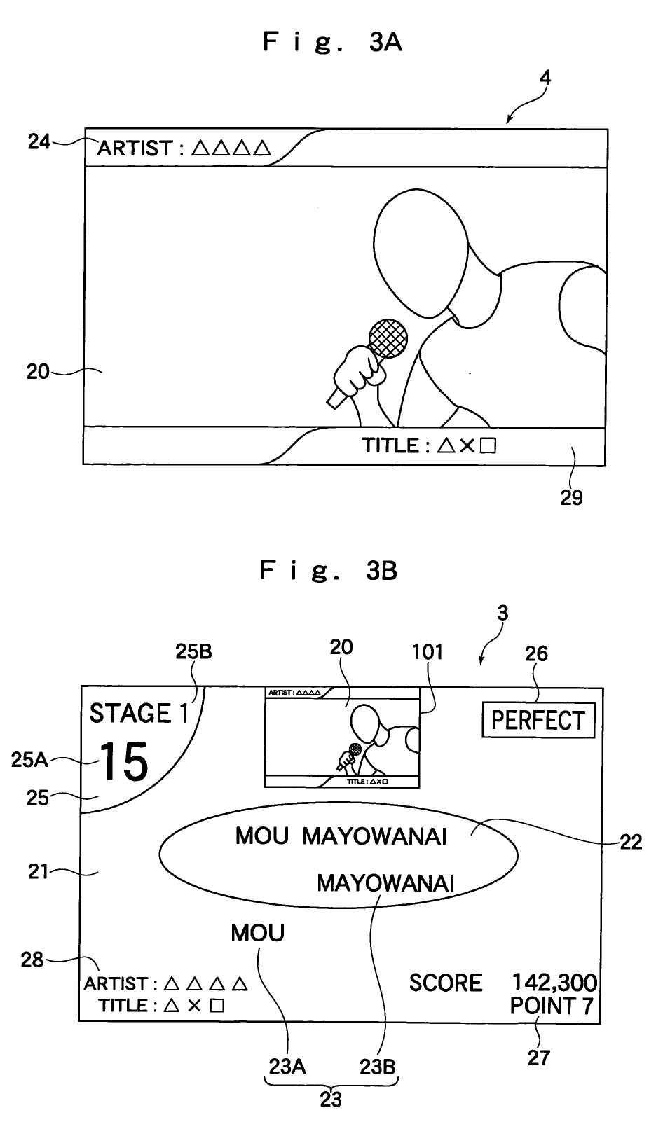

FIG. 3A is a pattern diagram showing a display content displayed on a second liquid crystal display during the execution of the typing game;

FIG. 3B is a pattern diagram showing a display content displayed on the first liquid crystal display during the execution of the typing game;

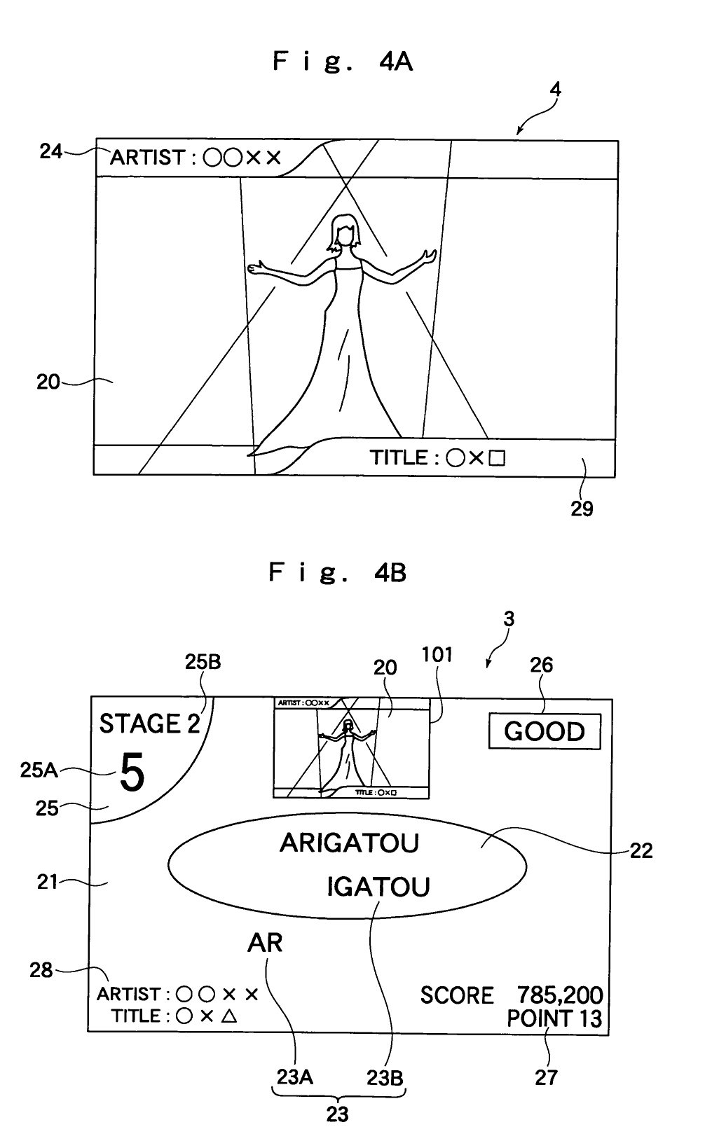

FIG. 4A is a pattern diagram showing a display content displayed on the second liquid crystal display during the execution of the typing game;

FIG. 4B is a pattern diagram showing a display content displayed on the first liquid crystal display during the progress of the typing game;

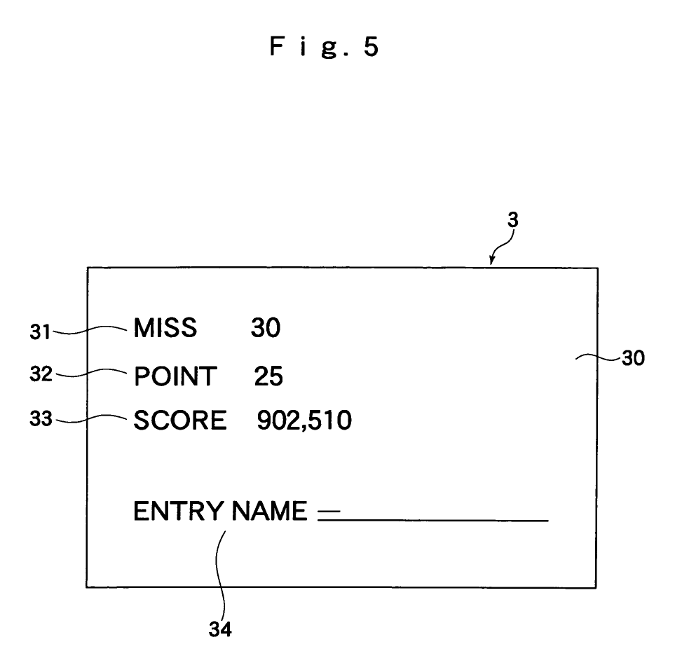

FIG. 5 is a pattern diagram showing a display content displayed on the first liquid crystal display after the end of the typing game;

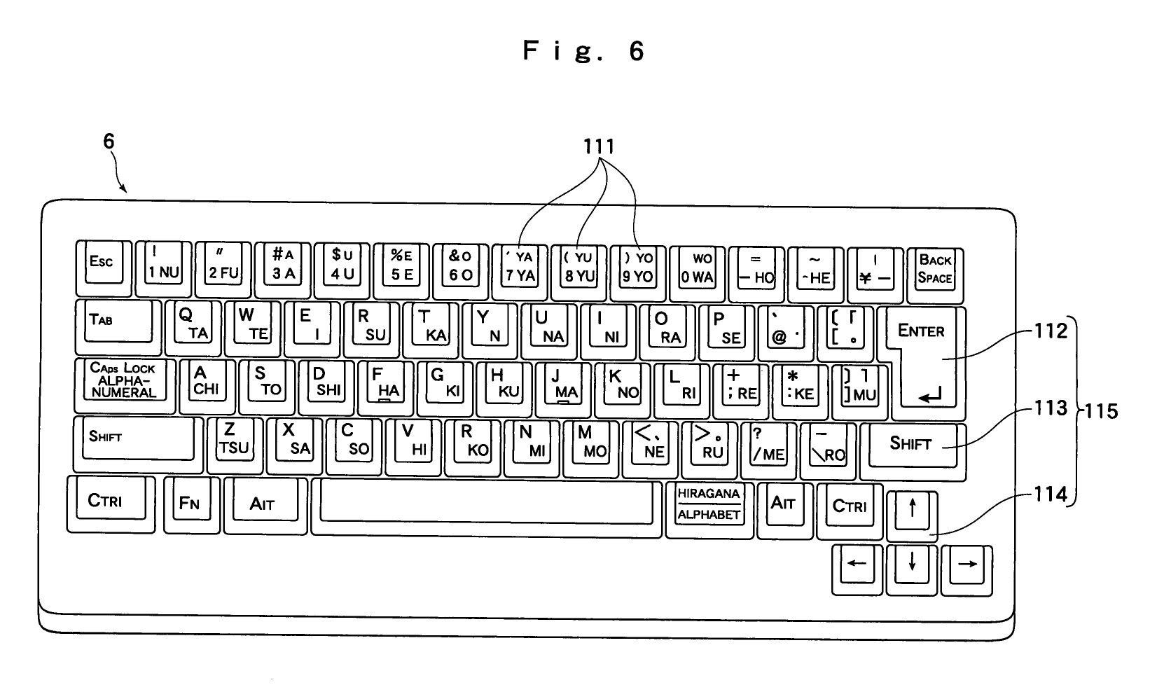

FIG. 6 is a plan view of a keyboard installed on the typing game apparatus according to the embodiment;

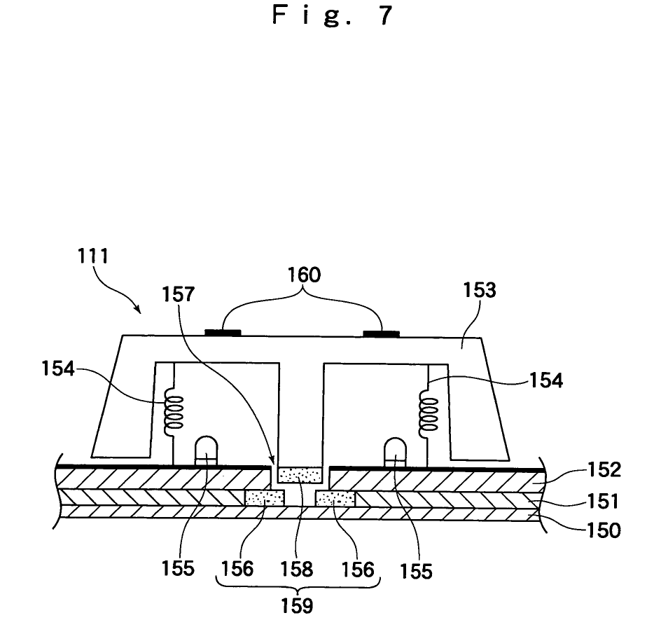

FIG. 7 is a schematic sectional view of any one of plural keys provided on the keyboard;

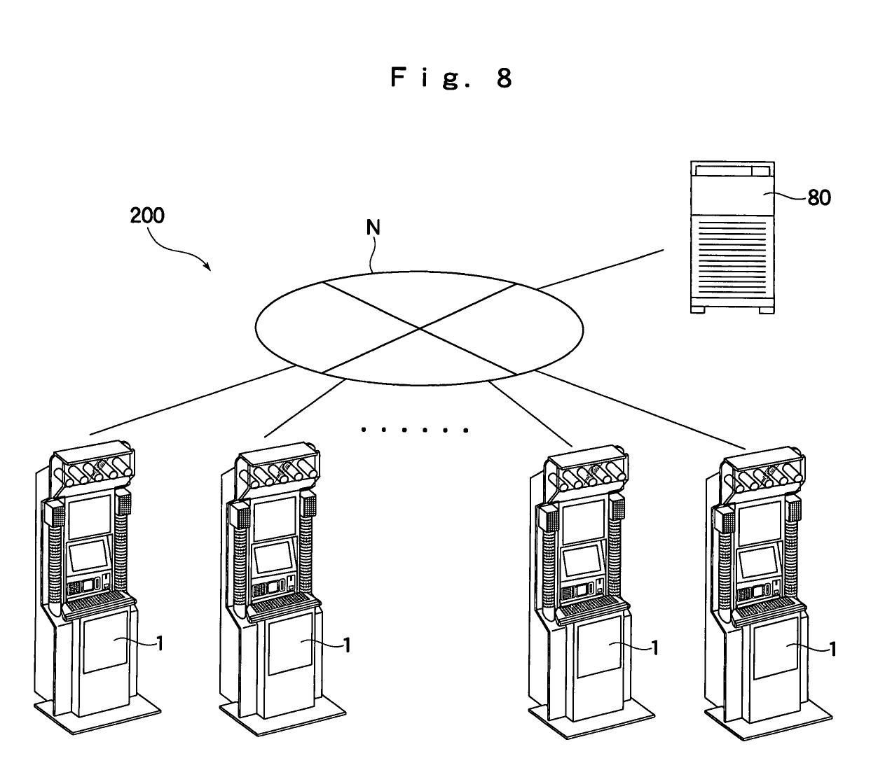

FIG. 8 is a system block diagram showing a system including a server and the typing game apparatus according to the embodiment;

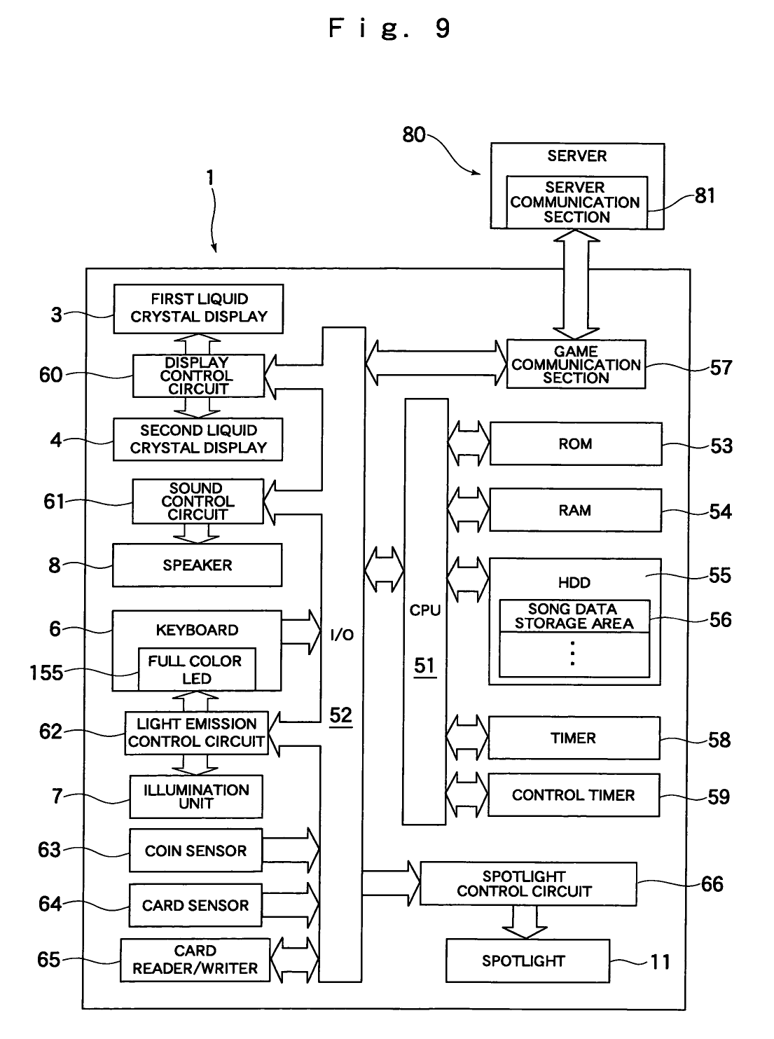

FIG. 9 is a block diagram showing schematically a control system of the typing game apparatus according to the embodiment;

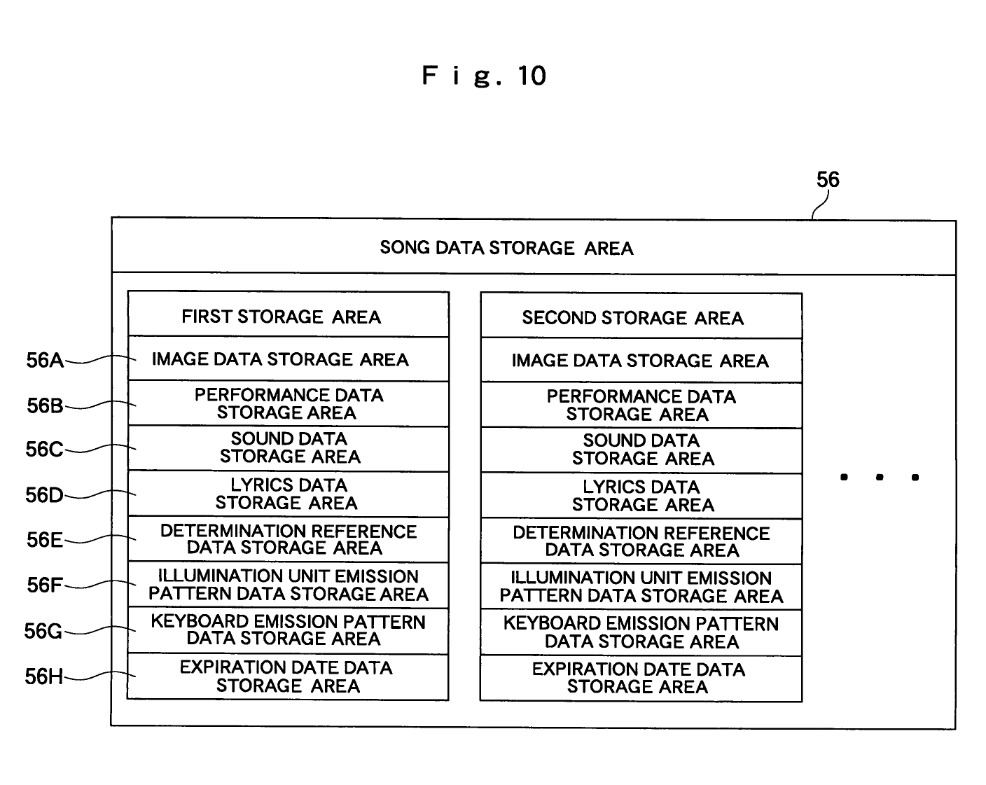

FIG. 10 is a schematic diagram showing a song data storage area of an HDD of the typing game apparatus according to the embodiment;

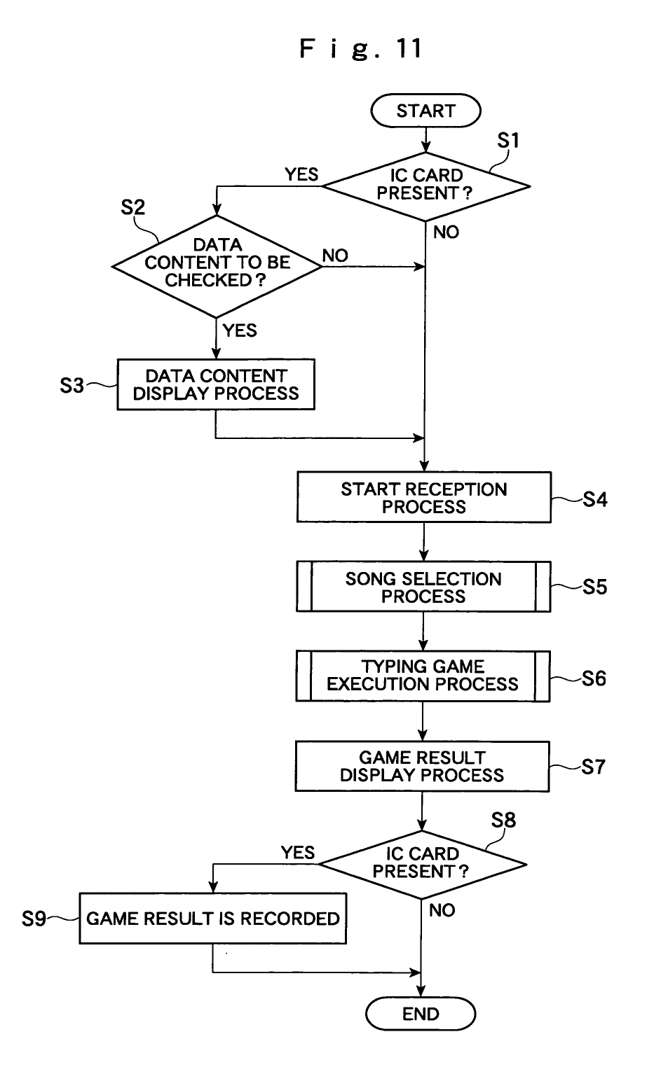

FIG. 11 is a flowchart of a main processing program of the typing game apparatus according to the embodiment;

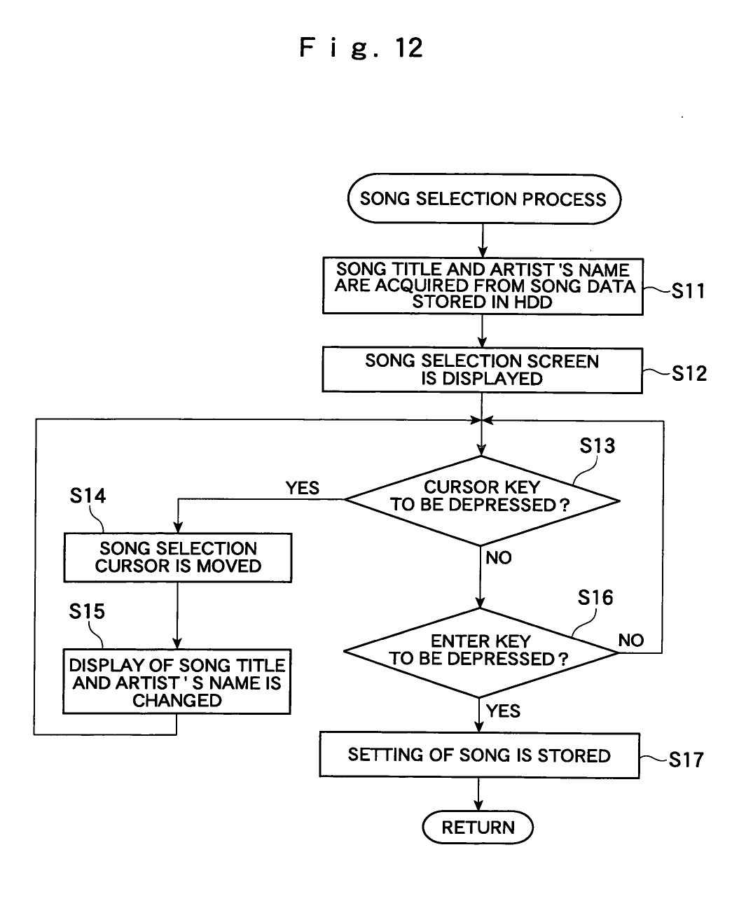

FIG. 12 is a flowchart of a song selection processing program of the typing game apparatus according to the embodiment;

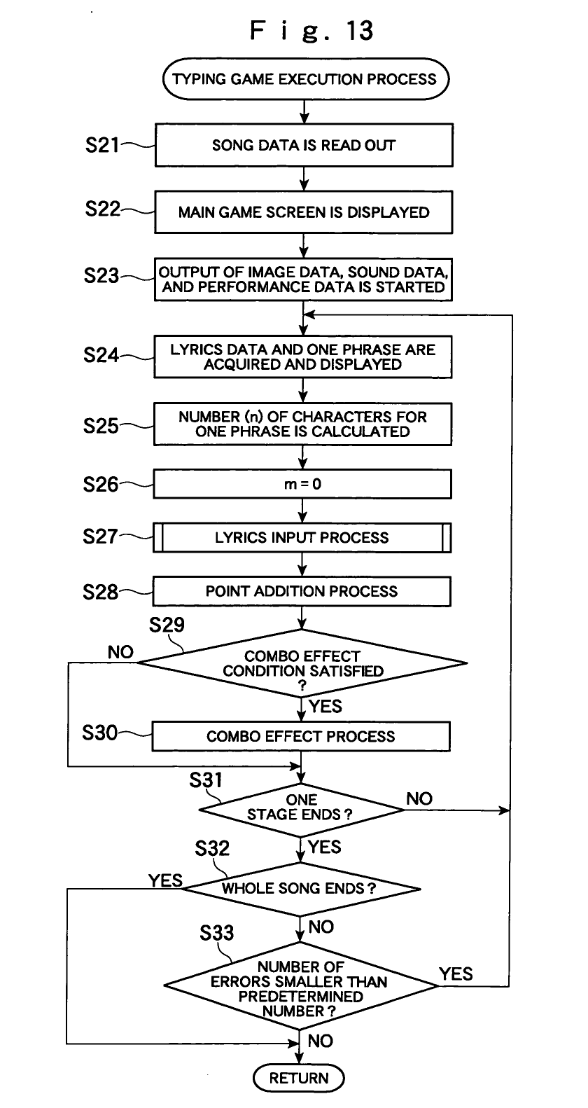

FIG. 13 is a flowchart of a typing game execution processing program of the typing game apparatus according to the embodiment;

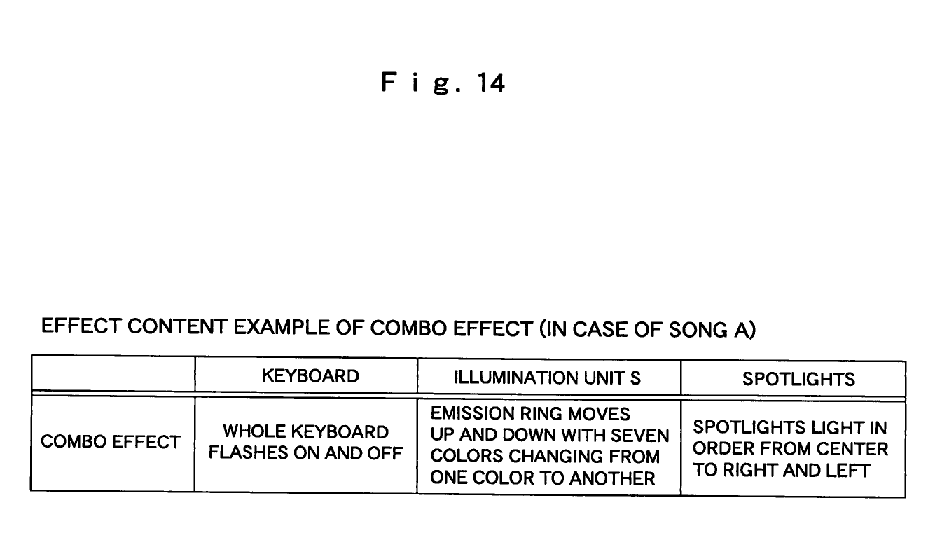

FIG. 14 is an illustration of an effect content related to a combo effect of the typing game apparatus according to the embodiment;

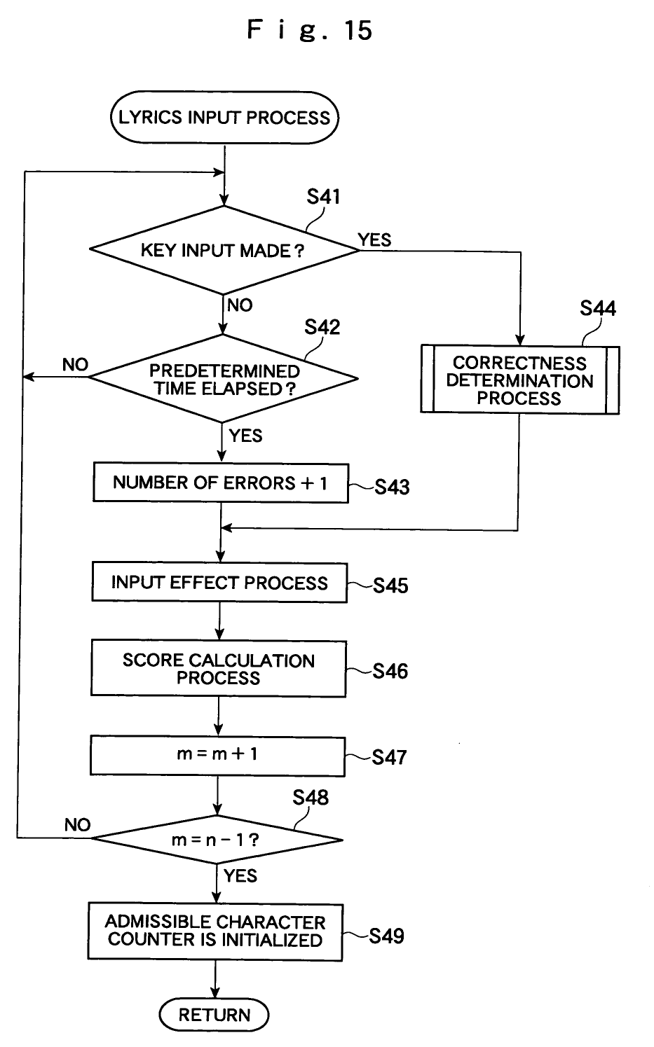

FIG. 15 is a flowchart of a lyrics input processing program of the typing game apparatus according to the embodiment;

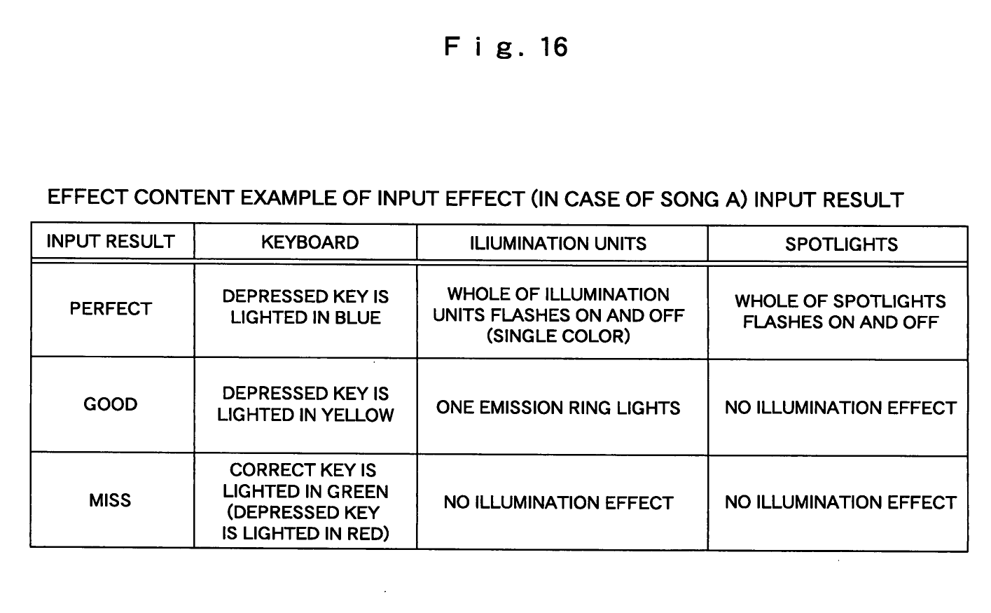

FIG. 16 is an illustration of en effect content related to a input effect of the typing game apparatus according to the embodiment; and

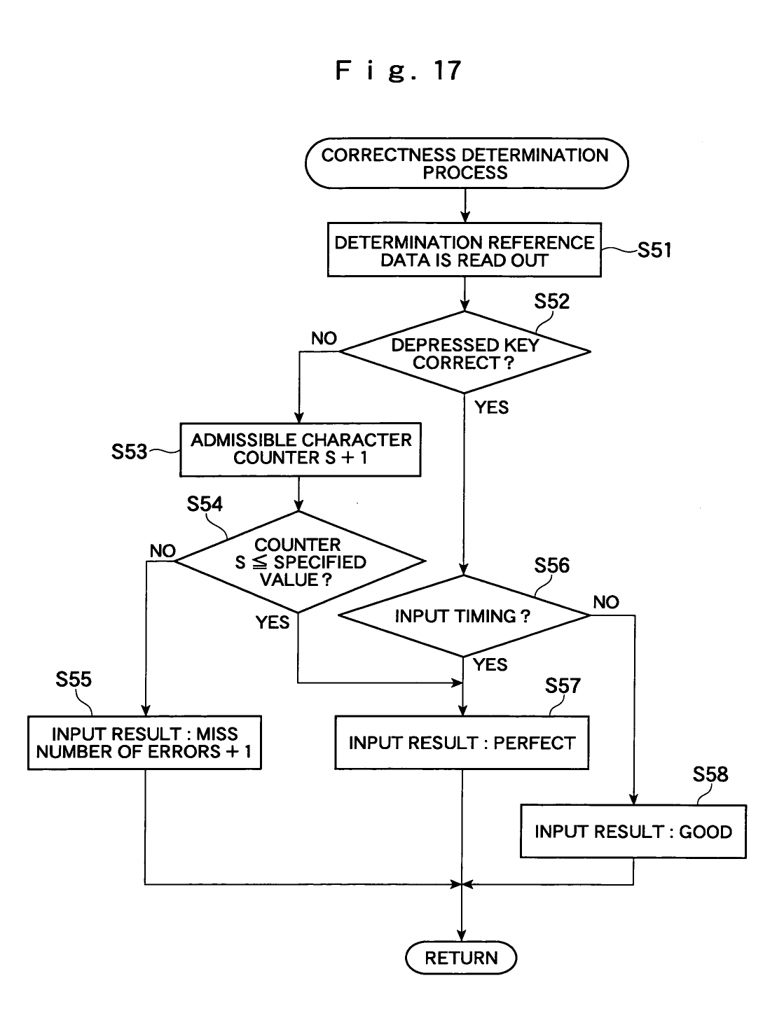

FIG. 17 is a flowchart of a correctness determination processing program of the typing game apparatus according to the embodiment.

### DESCRIPTION OF THE PREFERRED EMBODIMENT(S)

A typing game apparatus according to the invention will hereafter be described in detail, with reference to the drawings, based on an embodiment which is embodied in a cabinet-type typing game apparatus to be installed in a game center or the like.

As used herein, the typing game apparatus according to this embodiment is a gaming apparatus which reproduces a song from a speaker and leads a player to execute a game in synchronization with the song from the speaker. In this embodiment, lyrics of a song are sequentially displayed on a display, and the player can execute a typing game which is played by using a keyboard to type the displayed lyrics in sequence.

The typing game, which is conducted on the typing game apparatus of this embodiment, is configured as follows. That is, the typing game comprises a plurality of stages in accordance with the number of verses of a song to be reproduced. When the number of typing errors by the player is less than a predetermined number at the end of one stage, the typing game moves to a stage corresponding to the next verse of the song, and can thus continue.

First, the outlined configuration of the typing game apparatus of this embodiment will be described in accordance with FIG. 1. FIG. 1 is a perspective view of the typing game apparatus of this embodiment.

As shown in FIG. 1, the typing game apparatus 1 of this embodiment principally includes a cabinet 2, a first liquid crystal display 3, a second liquid crystal display 4, a center panel 5, a keyboard 6, a pair of illumination units 7, a pair of speakers 8, five spotlights 11, and the like. The cabinet 2 forms the exterior of the typing game apparatus 1. The first liquid crystal display 3 displays a main game screen (see FIGS. 3B and 4B). The second liquid crystal display 4, provided above the first liquid crystal display 3, displays images (see FIGS. 3A and 4A) related to effects such as a promotional video and an advertisement. The center panel 5, provided below the first liquid crystal display 3, is formed with coin and card insertion slots. The keyboard 6 is used for the player to perform operations related to the game. The pair of illumination units 7 is provided at both ends of the front of the cabinet 2. The pair of speakers 8 is disposed on the left and right sides of the second liquid crystal display 4. The five spotlights 11 are disposed above the second liquid crystal display 4. The components will be described below.

The first liquid crystal display 3, which is a liquid crystal display disposed in the approximate center of the front of the cabinet 2, is inclined backward at a predetermined angle.

During the execution of the typing game, the first liquid crystal display 3 displays gaming information (information necessary for the player to proceed with the game) and the like related to the progress of the game on the typing game apparatus 1, such as the lyrics of a song reproduced via the speakers 8, a player's input result, and a score resulting therefrom (see FIGS. 3B and 4B).

The second liquid crystal display 4, disposed separately above the first liquid crystal display 3, is a liquid crystal display similar to the first liquid crystal display. During the execution of a typing game, however, the second liquid crystal display 4 displays effect images associated with effects of the game.

Unlike the aforementioned display contents displayed mainly on the first liquid crystal display 3, the effect images displayed on the second liquid crystal display 4, which are not directly required for the player to proceed with the game, have an auxiliary role in bringing excitement to the typing game.

For example, in the typing game apparatus 1 of this embodiment, a certain singer's song is reproduced as a song, and the game progresses as the player inputs characters, which are based on the lyrics of the song, from the keyboard 6. At this point, the second liquid crystal display 4 displays a promotional video (henceforth abbreviated as a PV) related to the song (see FIGS. 3A and 4A). Accordingly, this enables a typing game with a realistic ambience in which the image of an artist singing is displayed as his/her song is played, thus preventing the player from feeling bored.

The display contents displayed on the first and second liquid crystal displays 3 and 4 will be described in detail later.

The center panel 5 is provided with a coin insertion slot 9 and a card insertion slot 10. The coin insertion slot 9 is an insertion slot through which coins such as a 100-yen coin are inserted. A coin sensor 63 is disposed in the coin insertion slot 9. When a coin is inserted into the coin insertion slot 9, a coin detection signal is sent to a CPU 51 via the coin sensor 63 (see FIG. 9), and the CPU 51 detects that the coin has been inserted.

The card insertion slot 10 is an insertion slot through which is inserted an IC card (not shown) with a built-in IC tag on which the game result of a typing game is recorded. A card sensor 64 and a card reader/writer 65, to be described later, are disposed inside this card insertion slot 10 (see FIG. 9).

The IC card used in the typing game apparatus 1 of this embodiment stores in its built-in IC tag a game result (a score, points, and the like) obtained in the previous typing game(s) played by a player who possesses the IC card.

When the IC card is inserted into the card insertion slot 10, the card sensor 64 detects such insertion. Also, the card reader/writer 65 can read the stored game result from the IC tag built into the IC card, and write to the IC tag the result of the game executed by the player.

That is, by inserting the IC card into the card insertion slot 10 and performing a prescribed operation, the game result stored in the IC card can be read and displayed on the typing game apparatus 1 (see S3 in FIG. 11). This allows the player to check his/her own history of gaming information and, at the end of the execution of a typing game, store the current game result in the IC tag (S9 in FIG. 11).

The keyboard 6 is positioned projecting forwards from the front of the cabinet 2. As described later, the keyboard 6 is a Japanese 108 keyboard (see FIG. 6) having arranged thereon function keys, such as a plurality of character input keys, an enter key, cursor keys, and a space key, for use in inputting “roman letters (A to Z)”, “kana letters (A to N)”, “numbers (0 to 9)”, “symbols (such as a period and a comma)”, and the like. During a game, the player depresses the keys to input the corresponding letters, symbols, numbers, or the like, thereby proceeding with the game. Before a game starts, after a game ends, or in a like case, the player operates each key to issue instructions to determine the selection of a song to which a game is performed, to start the execution of a game, and so on. The configuration of the keyboard will be described in detail later.

The pair of illumination units 7 is disposed at both ends of the front of the cabinet 2. Each of the illumination units 7 includes a cylindrical transparent member, 24 full color LEDs which are capable of full color lighting, and a light shielding member.

The cylindrical transparent member, having a lenticular lens formed into a cylinder, is fixed to the cabinet 2 with the lengthwise direction of the cylinder positioned vertically. Also, the 24 full color LEDs are fixed to the light shielding member, being evenly spaced in the lengthwise direction of the light shielding member. The light shielding member having the full color LEDs fixed thereto is inserted inside the transparent member. Accordingly, the illumination unit 7 is placed in a state in which the 24 full color LEDs are evenly spaced in its inside.

In the illumination unit 7 of such a configuration, when one full color LED emits light, one ring-like light emitting mode (henceforth called an “emission ring”) in a horizontally laid position, as seen from the outside, can be expressed by the effect of the lenticular lens of the transparent member.

That is, by controlling the light emitting mode of the 24 full color LEDs, a maximum of 24 emission rings can be expressed, piled one on another in a vertical direction, which makes it possible to perform a variety of illumination effects in response to a song reproduced on the typing game apparatus 1, perform an illumination effect in response to player's typing progress, and so on. For example, the following effects are applicable as the illumination effects: the effect of varying the position and illumination color of the emission rings, the effect of varying the position and illumination color of the emission rings in accordance with a fixed pattern, the effect of turning on and off the emission rings, and the like.

The speakers 8 are located on both left and right of the second liquid crystal display 4. The speakers 8 are output devices which output songs, sound effects, and the like to be reproduced on the typing game apparatus 1. Specifically, during the execution of a typing game, the speakers 8 output music and sound at a designated tempo based on the sound data and performance data of a song which are stored in an HDD 55 (see FIG. 9).

Next, the display contents to be displayed on the first and second liquid crystal displays 3 and 4 will be described in detail using FIGS. 2 to 5. The display contents to be displayed on the first and second liquid crystal displays 3 and 4 each basically include three patterns: a pattern before a game start, a pattern during a game execution, and a pattern after a game end.

First, the display content before the game start will be described using FIG. 2. FIG. 2 is a pattern diagram showing a display content displayed on the first liquid crystal display 3 before the game start.

In the typing game apparatus 1 of this embodiment, it is possible to execute a typing game in which the game progresses by inputting the lyrics of a song being played. Accordingly, on the first liquid crystal display 3 after a number of coins equivalent to a predetermined amount of money has been inserted in the coin insertion slot 9 and before the start of a typing game, the player will select a song to be used in the current typing game.

A song selection screen 15 displayed on the first liquid crystal display 3 before the start of the typing game will now be described in detail with reference to FIG. 2.

The song selection screen 15 includes available song title display portions 16 which display the titles of songs available for gaming, a song selection cursor 17 which can be used to select any one of the available song title display portions 16, a selected song title display portion 18 which displays a song title selected using the song selection cursor 17, and a selected artist's name display portion 19 which displays the name of the artist of the song selected using the selection cursor.

The available song title display portions 16 display the titles of songs (in this embodiment, a maximum of eight songs) available for gaming on the current typing game apparatus 1. The available songs displayed in the available song title display portions 16 are songs whose song data are stored in the HDD 55, to be described later (see FIGS. 9 and 10), and furthermore, the song data stored is managed and sequentially updated by a server 80 (see FIG. 8). Accordingly, the player can play a game by selecting a song from among a plurality of songs including the latest song updated by the server 80. Not only the titles of songs but also the pictures and PVs of artists may be displayed in the available song title display portions 16.

The song selection cursor 17 can be moved up, down, left, and right along the available song title display portions 16 by operating the cursor keys 114 (see FIG. 6) of the keyboard 6. The title and artist's name of a song in an available song title display portion 16, on which the song selection cursor 17 is currently positioned, are displayed in the selected song title display portion 18 and the selected artist's name display portion 19, respectively.

When the enter key 112 (see FIG. 6) is depressed with the song selection cursor 17 positioned on an available song title display portion 16 where the title of a desired song is displayed, a song to which a game is to be played is determined, and the typing game is started based on the selected song.

Next, the display content during a game execution will be described with reference to FIGS. 3A to 4B. FIGS. 3A and 4A are pattern diagrams showing display contents displayed on the second liquid crystal display 4 during the execution of a typing game. FIGS. 3B and 4B are pattern diagrams showing display contents displayed on the first liquid crystal display 3 during the execution of a typing game.

FIGS. 3A and 3B are illustrations showing the display contents displayed on the first and second liquid crystal displays 3 and 4 when a song A sung by a male artist is selected from the song selection screen 15 to start a typing game. FIGS. 4A and 4B are illustrations showing the display contents displayed on the first and second liquid crystal displays 3 and 4 when a song B sung by a female artist is selected from the song selection screen 15 to start a typing game.

As shown in FIG. 3A, for example, when the song A is selected to start the game, a PV image 20 of the male artist singing the song A, played via the speakers 8, is displayed on the second liquid crystal display 4. In contrast, as shown in FIG. 4A, for example, when the song B is selected to start the game, a PV image 20 of the female artist singing the song B, played via the speakers 8, is displayed on the second liquid crystal display 4.

At the same time, as shown in FIGS. 3B and 4B, the main game screen 21, which is related to the progress of a typing game, is displayed on the first liquid crystal display 3 while the PV image 20 is concurrently being displayed on the second liquid crystal display 4.

The main game screen 21 includes a lyrics display portion 22, a roman letter display portion 23, a song status display portion 25, an input result display portion 26, a score display portion 27, a song information display portion 28, and the like. The lyrics display portion 22 displays the lyrics of a phrase being currently played in Chinese characters, kana letters, or the like. The roman letter display portion 23 displays the lyrics displayed in the lyrics display portion 22 separately in roman letters and shows the result of the input which the player has made by typing on the keyboard 6. The song status display portion 25 displays what number verse (what number stage), and furthermore what number phrase counting from the start of this verse, the phrase of lyrics currently displayed in the lyrics display portion 22 and the roman letter display portion 23 corresponds to. The input result display portion 26 displays a player's typing correctness determination result. The score display portion 27 displays a score, points, and the like which the player has acquired so far. The song information display portion 28 displays the artist's name and title of the song being currently played.

The lyrics display portion 22 is a display portion which displays lyrics for one phrase of a song being currently played. Accordingly, the game progresses as the player inputs lyrics displayed in the lyrics display portion 22 from the keyboard 6.

When the player correctly inputs the lyrics displayed, scores are gradually added, while, when the player erroneously inputs lyrics, in principle, a score is not added, and furthermore the number of errors is added as the number of inputting errors.

In the event that this number of typing errors has reached the predetermined number or more at the end of any one of the verses (stages) which form a song, the game is brought to an end at that time (see S33 in FIG. 13).

Similar to the lyrics display portion 22, the roman letter display portion 23 also displays lyrics for one phrase of a song being currently played, but displays the same lyrics in roman letters. Furthermore, out of the lyrics displayed, a character string 23A which the player has already typed is moved and displayed lower than a character string 23B to be typed, thereby making it possible to notify the player of the characters typed so far.

The song status display portion 25 displays what number verse, and what number phrase counting from the start of the verse, the phrase of lyrics currently displayed in the lyrics display portion 22 and the roman letter display portion 23 corresponds to.

The typing game of this embodiment includes a plurality of stages (e.g., the first to third stages) in response to the number of verses (e.g., one song includes one to three verses) of a song to be reproduced. For example, FIG. 3B shows that the 15th phrase of the first stage is currently being displayed. Besides, FIG. 4B shows that the fifth phrase of the second stage is currently being displayed.

Each time the player finishes inputting one phrase, “1” is added to a numeric value 25A indicating the number of phrases, and each time the player finishes inputting one stage, “1” is added to a numeric value 25B indicating the number of stages (verses). This makes it possible to notify the player of the current number of stages (verses) and the number of phrases typed so far.

In the input result display portion 26, which is a display portion for displaying a player's typing correctness determination result, “PERFECT” is displayed when correct characters have been input at the correct timing. Besides, “GOOD” is displayed when correct characters have been input but the input timing is out of synchronization. Conversely, “MISS” is displayed when erroneous characters have been input, regardless of a key input timing.

The score display portion 27 is a display portion which displays a score and points which the player has acquired so far. A score is added as the player types correctly in accordance with character strings displayed in the lyrics display portion 22 and the roman letter display portion 23. Another score is added when appropriate characters have been typed in a concurrent timed relationship with the sound of a song being played.

On the other hand, one point is added each time an input is made without mistyping text for one phrase (S28 in FIG. 13).

A score and points are added until the game ends, and when the IC card has been inserted in the card insertion slot 10, the score and points acquired are stored in the IC card at the end of the game.

The song information portion 28 displays the title and artist's name of the song which the player has selected at the start of the game and which is currently being played.

As shown in FIGS. 3B and 4B, an independent image region 101 is provided in the central upper portion of the main game screen 21 of the first liquid crystal display 3. In the independent image region 101, the PV image 20 being displayed on the second liquid crystal display 4 is displayed in a concurrent timed relationship.

Next, the display content after the end of the game will be described in detail with reference to FIG. 5. FIG. 5 is a pattern diagram showing a display content displayed on the first liquid crystal display 3 after the end of a game.

As shown in FIG. 5, after the execution of a typing game ends, the first liquid crystal display 3 displays a game result screen 30 showing the game result of the currently executed typing game.

The game result screen 30 includes a number-of-errors display portion 31 which displays the number of typing errors in the current game, an acquired point display portion 32 which displays a number of points acquired, an acquired score display portion 33 which displays a score acquired, and a name input display portion 34 which prompts a player who has played the game to input his/her name.

Reference to the game result screen 30 enables the player to recognize the number of typing errors made and the points and score acquired in the current game. Additionally, an arbitrary name is input to the name input display portion 34 using the keyboard 6, thereby making it possible to register the acquired points in a ranking. The list of rankings registered is displayed in the first or second liquid crystal display 3 or 4 during the display of a demonstration screen or in a like case.

Subsequently, the keyboard 6 installed on the typing game apparatus 1 will be described using FIGS. 6 and 7. FIG. 6 is a plan view showing the keyboard installed on the typing game apparatus of this embodiment. FIG. 7 is a schematic sectional view of any one of a plurality of keys provided on the keyboard.

As shown in FIG. 6, the keyboard 6 is a Japanese 108 keyboard having arranged thereon a plurality of character input keys 111 for use in inputting “roman letters (A to Z)”, “kana letters (A to N)”, “numbers (0 to 9)”, “symbols (such as a period and a comma)”, and the like, and function keys 115, such as the enter key 112, the shift key 113, and the cursor keys 114.

During a game, the player operates the character input keys 111 and inputs lyrics displayed in the lyrics display portion 22, thereby proceeding with a typing game.

Besides, as described later, light emitting LEDs are installed inside the various keys of the keyboard 6, and are configured to emit light in a variety of modes based on control signals from the CPU 51.

The key internal structure of the keyboard 6 will now be described in accordance with FIG. 7. The plurality of keys arranged on the keyboard 6 all have the same internal structure. Accordingly, out of the plurality of keys arranged on the keyboard 6, the internal structure of one character input key 111 will hereafter be described as an example, and the other character input keys 111 and the function keys 115 will be omitted from the description.

As shown in FIG. 7, the character input key 111 principally includes a substrate 150, a switch circuit board 151, a light emitting circuit board 152, a keycap 153, a biasing mechanism 154, full color LEDs 155, and the like.

The switch circuit board 151 laid on the substrate 150 is provided with a pair of electrodes 156 located right directly under the center of the keycap 153.

The light emitting circuit board 152 laid on the switch circuit board 151 is provided with an opening 157 for exposing the pair of electrodes 156. The full color LEDs 155 capable of full color lighting are provided around the opening 157.

The biasing mechanism 154, provided between the light emitting circuit board 152 and the keycap 153, biases the keycap 153 toward the side opposite the switch circuit board 151. Furthermore, an electrode 158 projects from the center of the keycap 153 toward the switch circuit board 151.

Accordingly, when the keycap 153 is depressed, the electrode 158 projecting from the keycap 153 can be brought into contact with the pair of electrodes 156 provided on the switch circuit board 151. Therefore, the depression of the keycap 153 can be transferred as an electrical signal, flowing through the switch circuit board 151. That is, these three electrodes 156 and 158 configure a key switch 159.

It is not considered important whether the biasing mechanism 154 is configured of only an elastic body, or of an elastic body and a cross-linking mechanism.

The keycap 153 is formed of a material having transparency (e.g., transparent acryl or transparent plastic), and key information 160, such as a character, a number, or a symbol, is printed in black on the flat surface portion of the keycap 153. Furthermore, the surface of the light emitting circuit board 152 on the keycap 153 side is also printed black.

Accordingly, while the full color LEDs 155 are off, the transparent keycap 153 is reflected in black which is the color of the surface of the light emitting circuit board 152, thereby making it difficult to recognize the key information 160 printed in black on the keycap 153.

Conversely, while the full color LEDs 155 are on, the transparent keycap 153 is reflected in the color in which the full color LEDs 155 are lighted, which therefore makes it easy to recognize the key information 160 printed in black on the keycap 153 reflected in that color.

In the keyboard 6, the key switch 159 inside each key is connected to a transmission circuit (not shown). The transmission circuit is connected to the CPU 51 of the typing game apparatus 1 via an interface unit 52 (henceforth called an I/O) to be described later. Accordingly, an electrical signal from the key switch 159 of a key depressed is transmitted to the CPU 51 via this transmission circuit, and the kind of the key depressed can thereby be specified. The transmission circuit is mounted on the switch circuit board 151.

Additionally, in the keyboard 6, the full color LEDs 155 inside each key are connected to a light emission control circuit 62. Furthermore, the light emission control circuit 62 is connected to the CPU 51 via the I/O 52 (see FIG. 9). Accordingly, via this light emission control circuit 62, the full color LEDs 155 inside this key can be lighted in a color specified by the CPU 51.

Specifically, in the typing game apparatus 1 of this embodiment, during a typing game, when a key input has been made and when a correct character is determined to have been input at the correct timing (in the case of “PERFECT”), the character input key 111 depressed is illuminated in blue.

Besides, when a key input has been made with a correct key but the input timing is wrong (in the case of “GOOD”), the character input key 111 with which the input has been made is illuminated in yellow.

Conversely, when a key input has been made but the key with which the input has been made is wrong (in the case of “MISS”), the character input key 111 depressed is illuminated in red, and a correct key with which an input should be made is illuminated in green. Furthermore, when there is no key input (in the case of “MISS”), only a correct key with which an input should be made is illuminated in green.

As shown in FIG. 8, the typing game apparatus 1 of this embodiment is connected to the server 80 via a network N capable of reciprocal communication, such as the Internet. Song data stored in the HDD 55 (see FIG. 9) of the typing game apparatus 1 can thus be updated based on data transmitted from the server 80.

Accordingly, the kind of songs available for gaming on the typing game apparatus 1 can be changed by updating the song data. Also, typing game apparatuses installed in game shops are collectively managed, thereby facilitating their data update operation.

Next, the configuration of the control system of the typing game apparatus 1 will be described in accordance with FIG. 9. FIG. 9 is a block diagram showing schematically the control system of the typing game apparatus of this embodiment.

As shown in FIG. 9, the control system of the typing game apparatus 1 includes the CPU 51 in charge of various controls such as a game process operation on the typing game apparatus 1, a ROM 53 and a RAM 54 which are connected to the CPU 51, and a peripheral device (actuator) electrically connected to this CPU 51.

The CPU 51 is a central processing unit which performs calculation in accordance with a variety of commands. The I/O 52 is a connection which provides a direct/indirect electrical connection between the CPU 51 and the first liquid crystal display 3, the second liquid crystal display 4, the keyboard 6, the illumination units 7, the speakers 8, and the like.

The ROM 53 is a nonvolatile read-only memory which stores a calculation program for actuating flowcharts to be described later.

The RAM 54 is a memory which temporarily stores various data calculated by the CPU 51, and it also stores the number of typing errors made by the player, the score acquired, the points acquired, and the like during the typing game.

Besides, out of a plurality of pieces of song data stored in the HDD 55 to be described later, the lyrics data of a piece of song data to be used in the current game is divided into segments, one for each phrase, and the segments of lyrics data are stored in the RAM 54.

The HDD 55 is a storing section which stores song data to be used in the execution of the game on the typing game apparatus 1. The song data includes image data, performance data, sound data, lyrics data, determination reference data, illumination unit emission pattern data, keyboard emission pattern data, and expiration date data. These pieces of data are stored in the respective storage regions of a song data storage area 56 formed in the HDD 55 (see FIG. 10).

A plurality of pieces (in this embodiment, a maximum of eight pieces) of song data are stored in the song data storage area 56, and each piece of song data stored is updated on an as needed basis based on the data transmitted from the server 80 as described above. The kind of a song title displayed in the song selection screen 15 (see FIG. 2) varies based on the kind of song data stored in the song data storage area 56, and a game is performed based on song data corresponding to a song selected from the song selection screen 15 (see FIGS. 3A to 4B).

The song data storage area 56 formed in the HDD 55 will now be described in more detail using FIG. 10. FIG. 10 is an illustration showing schematically the song data storage area.

As shown in FIG. 10, the song data storage area 56 of the typing game apparatus 1 of this embodiment includes a plurality of storage regions (in this embodiment, a first storage area to an eighth storage region) corresponding to the number of pieces of storable song data. Each storage region is provided with an image data storage area 56A, a performance data storage area 56B, a sound data storage area 56C, a lyrics data storage region 56D, a determination reference data storage area 56E, an illumination unit emission pattern data storage area 56F, a keyboard emission pattern data storage area 56G, and a expiration date data storage area 56H.

A description will now be given of the data storage regions which configure each storage region formed in the song data storage area 56. The image data storage area 56A is a storage region which, out of the song data, stores image data regarding the PV image 20 (see FIGS. 3A and 4A). Accordingly, during the execution of a typing game, the image data regarding the PV image 20 is read from the image data storage area 56A and displayed concurrently on the independent image region 101 of the first liquid crystal display 3 and on the second liquid crystal display 4.

The performance data storage area 56B is a storage region which, out of the song data, stores performance data regarding the performance of a musical instrument and the like, which is output from the speakers 8.

The sound data storage area 56C is a storage region which, out of the song data, stores sound data regarding the singing voice of an artist, which is output from the speakers 8.

The lyrics data storage region 56D is a storage region which, out of the song data, stores lyrics data regarding the text data of the lyrics of a song. During the execution of a game, as described above, the lyrics data of the song is divided into segments, one for each phrase, and the segments of lyrics data are stored in the RAM 54. Then, as the song progresses, the segments of lyrics data are sequentially read from the RAM 54, one for each phrase, and thus displayed on the first liquid crystal display 3 (see FIGS. 3B and 4B).

The determination reference data storage area 56E is a storage region which, out of the song data, stores determination reference data to be read as the reference for determining, during the execution of a typing game, the correctness of characters which the player has typed and the correctness of input timing. That is, the determination reference data includes depressed key determination reference data, which is a determination reference to be used in determining the correctness of a key with which an input has been made, and input timing determination reference data, which is used in determining the timing of a key input. Based on the determination reference data stored and an operational signal from the keyboard 6, the CPU 51 makes a determination as to “PERFECT”, “GOOD”, and “MISS”, and adds the number of errors, a score, points, and the like, as described later.

The illumination unit emission pattern data storage area 56F and the keyboard emission pattern data storage area 56G are storage regions which, out of the song data, store illumination unit emission pattern data for allowing the illumination units 7 and the spotlights 11 to emit light and keyboard emission pattern data for allowing the full color LEDs 155 located inside each key to emit light, respectively.

In the typing game apparatus 1 of this embodiment, based on the illumination unit emission pattern data, the light emission control circuit 62 controls the pair of illumination units 7 so as to emit light in their respective emission modes (e.g., light color and turning on and off) during the execution of a typing game. Furthermore, similar to the illumination units 7, the spotlights 11 located in the upper portion of the cabinet 2 are controlled so as to emit light based on the illumination unit emission pattern data stored.

Besides, based on the LED emission pattern data, the light emission control circuit 62 controls the full color LEDs 155 located inside each key so as to emit light in their respective emission modes (e.g., light color and turning on and off) during the execution of a typing game.

An emission pattern, which is used in a combo effect to be described later, and an emission pattern, which is used in an input effect to be performed based on a key input determination result, are stored respectively in the illumination unit emission pattern and the keyboard emission pattern data, which are included in each song data.

The expiration date data storage area 56H is a storage region which, out of the song data, stores expiration date data regarding the expiration date of the song data. The expiration date data includes two pieces of date data: the date (use start date) on which the song data becomes usable and the date (use end date) on which the song data becomes unusable. This expiration date data is used to manage the expiration date of each piece of song data together with a timer 58 (see FIG. 9), and a typing game which uses outdated song data is controlled by the CPU 51 so as to be discontinued.

Referring now back to FIG. 9, the control system of the typing game apparatus 1 will continue to be described.

A game communication section 57 is a device which converts a signal sent from the typing game apparatus 1 into a signal of communicable form in response to the communication form of a telephone line, a LAN cable, and the like, and transmits the converted signal to the server 80, and which receives a signal transmitted from the server 80 and reconverts the received signal into a signal of a form readable by the typing game apparatus 1. The game communication section 57 is connected to a server communication section 81 of the server 80 via the network N capable of reciprocal communication such as the Internet (see FIG. 8).

Furthermore, the timer 58 is connected to the CPU 51. Information from the timer 58 is transmitted to the CPU 51, and the CPU 51 manages the expiration date of the song data stored, based on the information of the timer 58 and the expiration date data stored in the expiration date data storage area 56H of the HDD 55.

A display control circuit 60, connected to the CPU 51 via the I/O 52, is a portion which controls the display contents of the first and second liquid crystal displays 3 and 4 in response to the computation result of the CPU 51. The display control circuit 60 includes a program ROM, an image ROM, an image control CPU, a work RAM, a VDP (Video Display Processor), a video RAM, and the like.

The program ROM stores an image control program regarding the display on the first and second liquid crystal displays 3 and 4, and a variety of selection tables. Particularly, the first liquid crystal display 3 is provided with the independent image region 101, and the program ROM stores the image control program and the variety of selection tables which are required when the PV image 20 is displayed concurrently on the independent image region 101 and on the second liquid crystal display 4.

The image ROM stores, for example, dot data for forming images such as the song selection screen 15 (see FIG. 2) and the main game screen 21 (see FIGS. 3A to 4B) which are displayed on the first liquid crystal display 3.

Based on a parameter set by the CPU 51, the image control CPU determines images to be displayed on the first and second liquid crystal displays 3 and 4 out of the dot data pre-stored in the image ROM, in accordance with the image control program pre-stored in the program ROM. The VDP forms images corresponding to the display contents determined by the image control CPU and outputs the formed images to the first and second liquid crystal displays 3 and 4.

The image control CPU thus exerts, for example, the following controls. That is, in a standby state, a demonstration screen including the PV of an arbitrary song, an advertisement, a ranking list, and the like is displayed, and, after a coin is inserted into the coin insertion slot 9, the song selection screen 15 (see FIG. 2) is displayed on the first liquid crystal display 3.

While the typing game of the typing game apparatus 1 is being executed, the lyrics data included in the song data is displayed for each phrase on the first liquid crystal display 3, and based on the result of an input from the keyboard 6, the character string 23A already typed by the player is moved lower than the character string 23B to be typed.

At the same time, the PV, which is the image data included in the song data, is displayed on the second liquid crystal display 4. Furthermore, the independent image region 101 is provided in the central upper portion of the main game screen 21 of the first liquid crystal display 3, and this PV is displayed concurrently on the independent image region 101 and on the second liquid crystal display 4.

A sound control circuit 61 is connected to the CPU 51 via the I/O 52 and also connected to the speakers 8. When a game is executed and the song data stored in the song data storage area 56 of the HDD55 is read, the performance data and the sound data, which are included in this song data, are converted into a sound signal by the sound control circuit 61, and the sound signal is output from the speakers 8.

The light emission control circuit 62 is connected to the CPU 51 via the I/O and is also connected to the illumination units 7 and the full color LEDs 155 (see FIG. 9) located inside each key. When the CPU 51 reads the song data stored in the song data storage area 56 of the HDD 55, the light emission control circuit 62 controls the emission mode of the full color LEDs 155 based on the keyboard emission pattern data which is included in this song data, and also controls the emission mode of the illumination units 7 based on a to-be-described typing game execution processing program (see FIG. 13) and the like, in addition to the illumination unit emission pattern data which is included in this song data.

Furthermore, the keyboard 6 is connected to the CPU 51. The key switch 159 provided inside each key of the keyboard 6 transmits an electrical signal which flows through the switch circuit board 151, indicating that the keycap 153 has been depressed. Based on a switch signal transmitted from each key switch 159 by the depression of each key, the CPU 51 exerts control to execute various operations corresponding to the respective keys.

The coin sensor 63 is a sensor which detects a coin (e.g., a 100-yen coin) used as payment for the execution of a typing game on the typing game apparatus 1. The coin sensor 63, disposed inside the coin insertion slot 9, is connected to the CPU 51 via the I/O 52. Accordingly, the coin sensor 63 transmits a coin insertion signal to the CPU 51 based on the insertion of a coin through the coin insertion slot 9. The CPU 51 detects the coin insertion signal equivalent to the predetermined amount of money (e.g., 200 yen) and thereby makes it possible to execute the game.

The card sensor 64 is a sensor which detects whether or not the IC card has been inserted in the card insertion slot 10, and the card reader/writer 65 is a unit which reads and writes data from the IC tag disposed in this IC card. The card sensor 64 and the card reader/writer 65, both disposed inside the card insertion slot 10, are connected to the CPU 51 via the 1/0 52. When the card sensor 64 has detected the IC card and when a prescribed operation has been performed, the card reader/writer 65 reads the game result of the previously performed typing game from the IC tag (S3 in FIG. 11). At the end of a typing game, the card reader/writer 56 writes a new game result (the score and points acquired) to the IC tag (S9 in FIG. 11).

A spotlight control circuit 66 is connected to the CPU 51 via the I/O 52 and also connected to the spotlights 11. The spotlight control circuit 66 controls the emission mode of the spotlights 11 based on a command from the CPU 51. Particularly, while the light emission control circuit 62 and the like are controlling the emission mode of the illumination units 7 based on the illumination unit emission pattern data, similarly, the spotlight control circuit 66 controls the emission mode of the spotlights 11 based on the illumination unit emission pattern data. The illumination effect during the execution of a typing game is thereby made extravagant.

Furthermore, a control timer 59 capable of timing on a ⅕-second basis is connected to the CPU 51. This control timer 59 is a timing device which is used in executing a variety of control programs to be described later. In this embodiment, particularly, the control timer 59 is referred to when the correctness of a key input timing is determined during the execution of a typing game.

Next, a main processing program of the typing game apparatus 1 of this embodiment will be described in detail with reference to the drawings. FIG. 11 is a flowchart of the main processing program of the typing game apparatus 1 of this embodiment.

Programs described below, shown by flowcharts in FIGS. 11 to 13, 15 and 17, are stored in the ROM 53 and RAM 54, which are installed in the typing game apparatus 1, and executed by the CPU 51.

As shown in FIG. 11, first, in S1, based on a detection signal from the card sensor 64, the CPU 51 determines whether or not the IC card has been inserted in the card insertion slot 10.

If it is determined that the IC card has been inserted (S1: YES), it is determined in S2 whether a data content check request from the player has been received or not. Conversely, if it is determined that the IC card has not been inserted (S1: NO), the process moves to S4.

In the typing game apparatus 1 of this embodiment, when the shift key 113 of the keyboard 6 is depressed before a coin is inserted and in the state in which the IC card is inserted in the card insertion slot 10, a list of the game result recorded in the IC card is displayed on the first liquid crystal display 3, thus enabling the player to check his/her own game result history.

Accordingly, in the determination of S2, based on an operational signal from the keyboard 6, it is determined whether the shift key 113 has been depressed or not. If it is determined that the shift key 113 has been depressed (S2: YES), data in the IC tag embedded in the IC card is read by the card reader/writer 65, and based on the data read, the list of the game result is displayed on the first liquid crystal display 3 (S3).

In S4, a start reception process is performed. Specifically, in the start reception process, it is determined whether or not a number of coins (such as 100-yen coins) equivalent to the predetermined amount of money (in this embodiment, 200 yen) has been inserted into the coin insertion slot 9.

Before the number of coins equivalent to the predetermined amount of money is inserted, the process is held on standby where, for example, a demonstration screen including a game screen for demonstration playing, the PV of an arbitrary song, an advertisement, a list of rankings, and the like is displayed on the displays.

In the typing game apparatus 1 of this embodiment, when the coins are inserted into the coin insertion slot 9, the coin sensor 63 detects them and sends a coin detection signal to the CPU 51. The CPU 51 can thereby determine that the player has inserted the coins.

When the number of coins equivalent to the predetermined amount of money has been inserted and the start reception process (S4) has been brought to an end, the process moves to a song selection process (S5).

Subsequently, in S5, the song selection process, which selects a song to be used in executing the current typing game, is performed. In the song selection process (S5), as described later, based on the kind of the song data stored in the song data storage area 56 of the HDD 55, the song selection screen 15 (see FIG. 3) is displayed on the first liquid crystal display 3, thus setting a song to be used in the current game. The song selection process (S5) will be described in detail later with reference to the drawings.

When a song to be used in the current typing game has been determined in the song selection process (S5), then in S6, the process moves to a typing game execution process (S6).

In the typing game execution process (S6), a typing game, in which the song selected in the song selection process (S5) is played and points, a score, and the like are added based on the result of inputting from the keyboard 6, is continuously performed until predetermined end conditions are satisfied. When the predetermined end conditions have been satisfied and the typing game has ended, the typing game execution process (S6) is brought to an end, and the process moves to S7. The details of the typing game end process (S6) will be described later with reference to the drawing.

In S7, based on the result of the game executed in the typing game execution process (S6), a game result display process is performed (S7) for displaying the game result screen 30 on the first liquid crystal display 3 (refer to FIG. 5).

The game result screen 30 displays the number of errors made, points acquired, and a score acquired in the current game, which are stored in the RAM 54. Furthermore, the game result screen 30 displays the name input display portion 34 which prompts a player who has played the current game to input his/her name. Further still, the game result screen 30, when the keyboard 6 is operated in such a condition, based on the operational signal, displays the characters input to the name input display portion 34. After the game result display process (S7) is brought to an end, the process moves to S8.

In S8, based on a detection signal from the card sensor 64, the CPU 51 determines whether or not the IC card has been inserted in the card insertion slot 10. If it is determined that the IC card has been inserted (S8: YES), the points and score acquired in the current typing game, which are stored in the RAM 54, are written by the reader/writer 65 to the IC tag embedded in the IC card (S9).

The data written here becomes referable to in a data content display process (S3) during the next game.

Conversely, if it is determined that the IC card has not been inserted (S8: NO), this process is brought to an end.

Each process which comprises a main control program will now be described in detail with reference to the drawings.

First, a song selection processing program to be executed in the song selection process (S5) in the main control program will be described with reference to the drawing. FIG. 12 is a flowchart of the song selection processing program of this embodiment.

When the process moves to the song selection process (S5), first, the CPU 51 acquires the title and artist's name of a song (in this embodiment, a maximum of eight kinds) related to the song data stored from the song data storage area 56 of the HDD 55 (S11).

Based on the title and artist's name of the song acquired in S11, the song selection screen 15 (see FIG. 2) is displayed on the first liquid crystal display 3 (S12).

On the song selection screen 15, the song titles acquired are displayed as a list in the available song title display portion 16. At the same time, the title and artist's name of a song selected by the song selection cursor 17 are displayed respectively in the selected song display portion 18 and the selected artist's name display portion 19.

Subsequently, the CPU 51 determines in S13 whether or not there is an input from a cursor key 114. Whether or not there is an input from a cursor key 114 is determined based on an operational signal transmitted from the keyboard 6.

If it is determined that a cursor key 114 has been depressed (S13: YES), then based on the operation of a cursor key 114 (which of the up, down, left, and right keys has been depressed), the song selection cursor 17 displayed on the first liquid crystal display 3 is moved in the direction of the key depressed (S14).

Furthermore, in S15, the displays of the selected song title display portion 18 and the selected artist's name display portion 19 are changed to a song title and an artist's name which correspond to a song newly selected by the song selection cursor 17 moved in S14. The process thereafter returns to the determination process of S13.

Conversely, if it is determined that a cursor key 114 has not been depressed (S13: NO), it is determined whether the enter key 112 has been depressed or not (S16). If it is determined that the enter key 112 has been depressed (S16: YES), a song at which the song selection cursor 17 is positioned is set as a song to which the current typing game is to be performed, and a song selection result is stored in the RAM 54 (S17). By selecting and determining a song to be used in the current game, the song selection process (S5) is brought to an end, and the process returns to the main control program.

Conversely, if it is determined that the enter key 112 has not been depressed either (S16: NO), the process returns to the determination process of S13 again.

Subsequently, the typing game execution processing program to be executed in the typing game execution process (S6) in the main control program will be described in detail with reference to the drawing. FIG. 13 is a flowchart of the typing game execution processing program of this embodiment.

When a song to be used in a typing game is determined in the song selection process (S5), the process moves to the typing game execution process (S6), and the typing game using the selected song is executed.

When the process moves to the typing game execution process (S6), first, in S21, the CPU 51 reads, from the RAM 54, data indicating the song selected in the song selection process (S5). Then, based on the data, out of the song data stored in the storage regions (see FIG. 10) of the song data storage area 56 of the HDD 55, the CPU 51 reads song data corresponding to the selection result of the song selection process (S5). At this point, the lyrics data, stored in the lyrics data storage region 56D, is divided into segments, one for each phrase, and the divided segments of lyrics data are temporarily stored in the RAM 54.

Next, in S22, the CPU 51 displays the main game screen (see FIGS. 3B and 4B) on the first liquid crystal display 3. At this point, the independent image region 101 is formed in the central upper portion of the main game screen 21 on the first liquid crystal display 3.

Also, at this point, no character strings are displayed in the lyrics display portion 22 or roman letter display portion 23 of the main game screen 21, and the point and the score are also displayed as “0” in the score display portion 27. Furthermore, at this point, the PV image 20 is not displayed in the independent image region 101.

Subsequently, in S23, the CPU 51 reads the image data stored in the image data storage area 56A, and starts display of the PV image 20 concurrently in the independent image region 101 of the first liquid crystal display 3 and on the second liquid crystal display 4 (see FIGS. 3A and 4A).

Besides, the CPU 51 outputs a musical accompaniment and a sound via the speakers 8 based on the performance data stored in the performance data storage area 56B and the sound data stored in the sound data storage area 56C, respectively. It follows thereby that a song is played and the PV image 20 is reproduced in accordance with the song played.

Next, in S24, the CPU 51 acquires lyrics for one phrase out of the lyrics data stored in the RAM 54, and displays corresponding character strings, to the tempo of the playing of the song, in the lyrics display portion 22 and roman letter display portion 23 of the main game screen 21. The first liquid crystal display 3 thereby displays the main game screen 21 in synchronization with the playing of the song and the display of the PV image 20 on the second liquid crystal display 4 (see FIGS. 3B and 4B).

Thereafter, based on the lyrics data for the phrase acquired, the CPU 51 calculates the number n of characters in the phrase (S25), and assigns “0” to an arbitrary variable m stored in the RAM 54 (S26).

As used herein, the arbitrary variable m refers to a variable which is used for the input determinations of characters corresponding to the respective characters which form one phrase, and to which “1” is added each time the input determination of one character ends (S47 in FIG. 15). Accordingly, in the input determination processes which are repeated in a lyrics input process (S27) to be described later, when m=t (0≦t≦n−1), the input determination of a (t+1)th character from the beginning of one phrase is performed.

After “0” is assigned to the arbitrary variable m, in S27, the lyrics input process is performed. In the lyrics input process (S27), an inputting of each character, which forms the lyrics for the phrase acquired in S24, and a determination of the correctness of the inputting are performed. Accordingly, the lyrics input process (S27) is brought to an end when the inputting of all the characters which form the lyrics for the phrase acquired in S24, and the correctness determination, are finished and the process then moves to S28.

The lyrics input process (S27) will be described later in detail with reference to the drawing, and will thus be omitted from the detailed description here.

After the lyrics input process (S27) is brought to an end, a point addition process is performed in S28. In the point addition process (S28), if it is determined that an inputting of n characters which form one phrase has been completed without any typing errors (including a mistyping determination (S43) according to the elapse of a predetermined time), one point is added. That is, if all the characters which form the lyrics of one phrase are input with correct keys regardless of the correctness of input timing, a point can be obtained.

In S29, it is determined whether a combo effect condition has been satisfied or not. As used herein, the combo effect refers to an illumination effect which, when the combo effect condition has been satisfied, is rendered in a special light emitting mode by the full color LEDs 155 located inside each key of the keyboard 6, the illumination units 7, and the spotlights 11.

In this embodiment, the combo effect condition is that the result of the key input determination of all the characters which form the lyrics of one phrase has been determined to be “PERFECT”, i.e., that all the characters which form the lyrics of one phrase have been input with correct keys at correct timings.

If the combo effect condition has been satisfied (S29: YES), the process moves to S30 to perform the combo effect by the full color LEDs 155, the illumination units 7, and the spotlights 11.

The effect contents of the combo effect will now be described with a specific example. The effect contents of the combo effect will be described illustrating, for example, a combo effect rendered when a typing game is executed in accordance with the song A on the typing game apparatus 1 of this embodiment.

If “PERFECT” has been obtained as the determination result of the inputting of all the characters which form one certain phrase of the song A, the process moves to the combo effect process (S30) to perform the combo effect shown in FIG. 14.

That is, in the combo effect process (S30) in this case, all the full color LEDs 155 located inside the keys of the keyboard 6 flash on and off in a single color. At this point, the light emitting effect is rendered in the mode in which the emission rings move vertically along the illumination units 7 while varying in light color, in the order of “red”, “orange”, “yellow”, “green”, “blue”, “indigo”, and “violet”. Furthermore, the light emitting effect of the spotlights 11 is rendered in the mode in which five spotlights arranged side by side in a horizontal direction are lighted in order, from the spotlight 11 positioned in the center toward the spotlights on both right and left sides.

Such a combo effect, which is performed by the keyboard 6, the illumination units 7, and the spotlights 11 only when the combo effect condition has been satisfied, can notify a third person that a player's own game content is excellent, thereby improving the player's self-confidence. After the combo effect process (S30) is brought to an end, the process moves to S31.

Conversely, if the combo effect condition has not been satisfied, i.e., if even one character out of each character in one phrase falls under “GOOD” or “MISS” as its input determination result (S29: NO), the process moves to S31 without performing any illumination effects by the keyboard 6, the illumination units 7, or the spotlights 11.

In S31, the CPU 51 determines whether a phrase of a stage, which corresponds to any one of a plurality of verses (normally, one song comprises one to three verses) which forms a song, has ended or not. If it is determined that the input determination of the whole phrase for one stage has not ended (S31: NO), the process returns to S24 to acquire the lyrics of the next phrase from the RAM 54. A character string corresponding to the lyrics of the next phrase is thereby displayed in each of the lyrics display portion 22 and roman letter display portion 23 of the main game screen 21.

Conversely, if it is determined that the input determination of the whole phrase for one stage has ended (S31: YES), it is continuously determined whether the input determination of the phrases of all the stages (the whole song) has ended or not (S32).

If it is determined that all the stages have ended (S32: YES), the typing game execution process (S6) is brought to an end, regardless of the points which the player possesses, and the process returns to the main control program. Conversely, if it is determined that all the stages have not ended (S32: NO), it is determined whether or not the number of typing errors made so far by the player, which is added in a correctness determination process (S44 in FIG. 15) and S43, is smaller than the predetermined number (S33).

In the typing game apparatus 1 of this embodiment, a song to be reproduced comprises a plurality of stages in response to the number of verses in the song, and in order to continue to a stage related to the next verse when one stage ends, it is a condition that the number of typing errors from the game start is smaller than the predetermined number (e.g., the number of typing errors is less than 20 in order to continue to the second verse after a portion corresponding to the first verse has been played, and the number of typing errors is less than 35 in order to continue to the third verse after a portion corresponding to the second verse has been played).

If it is determined that the number of typing errors by the player, which is stored in the RAM 54, is smaller than the predetermined number (S33: YES), the process returns to S24, wherein lyrics corresponding to the first phrase of the next verse are acquired from the RAM 54, and a character string corresponding to the lyrics is displayed in each of the lyrics display portion 22 and the roman letter display portion 23. Then, the correctness determination is performed in the same manner. Conversely, if it is determined that the number of typing errors by the player is the predetermined number or greater (S33: NO), this typing game execution process (S6) is brought to an end, and the process returns to the main control program.

Next, a lyrics input processing program, which is executed in the lyrics input process (S27) of the aforementioned typing game execution process (S6), will be described in detail with reference to the drawing. FIG. 15 is a flowchart of the lyrics input processing program.

As described above, the lyrics input process (S27) is a process which performs an inputting of each character, which forms the lyrics for one phrase acquired in S24 and displayed in the lyrics display portion 22 and the roman letter display portion 23, and a determination of the correctness of the inputting.

When the process moves to the lyrics input process (S27), first, the CPU 51 determines, based on an operational signal from the keyboard 6, whether or not a key input has been made with the character input key 111 (S41).

When it is determined that a key input has been made (S41: YES), the kind of a key depressed is stored in the RAM 54, and input time data, which indicates the input timing of the key, is stored in the RAM 54 by the control timer 59. Thereafter, the process moves to the correctness determination process (S44) in which the determination of the correctness of the key depressed is performed based on the kind of the depressed key, the input time data, and the determination reference data stored in the determination reference data storage area 56E.

Conversely, if it is determined that a key input has been made (S41: NO), it is determined, based on information from the control timer 59, whether the predetermined time has elapsed or not (S42). At this point, in the case of inputting the first character of one phrase, the predetermined time is measured after a character string corresponding to the phrase is displayed on the main game screen 21 (S24 in FIG. 13), while, in the case of inputting the other characters, the predetermined time is measured after a score calculation process (S46) is performed.

Then, if it is determined by CPU 51 that the predetermined time has not elapsed (S42: NO), the process returns to the determination process of S41.

Conversely, if it is determined that the predetermined time has elapsed (S42: YES), a key input by the player is deemed not to have been made, wherein “1” is added to the number of errors in the current game, which has been stored in the RAM 54, and the determination result “MISS” is stored in the RAM 54 (S43).

A correctness determination processing program, which is executed in the correctness determination process (S44), will now be described in detail with reference to the drawing. FIG. 17 is a flowchart of the correctness determination processing program.

If, in S41, any one of the keys arranged on the keyboard 6 has been depressed (S41: YES), the process moves to the correctness determination process (S44). When the process moves to the correctness determination process (S44), the CPU 51 first reads the determination reference data stored in the determination reference data storage area 56E (S51).

Then, in S52, by comparing the kind of the depressed key, which is stored in the RAM 54, and the depressed key determination reference data, which is included in the determination reference data, it is determined whether the depressed key is a correct key or not. That is, it is determined whether or not the depressed key matches the depressed key determination reference data.

If the depressed key matches the depressed key determination reference data (S52: YES), the process moves to S56. Conversely, if the depressed key does not match the depressed key determination reference data (S52: NO), the process moves to S53.

In S53, “1” is added to the value of an admissible character counter S which is stored in the RAM 54. As used herein, the admissible character counter S is a counter which counts the number of times a key depressed by the player has not matched the depressed key determination reference data. The value of the admissible character counter S is a value which indicates the number of times erroneous keys have been input in one phrase, but, as described later, is initialized by inputting all the lyrics for one phrase.

After “1” is added to the value of the admissible character counter S, in S54, the CPU 51 compares a numeric value indicated by the admissible character counter S and a specified value of the number of admissible characters which is stored in the ROM 53.

The number of admissible characters in the typing game of this embodiment will now be described in detail. The number of admissible characters represents the number of inputs which have been so-called erroneous inputs, in which depressed keys do not match the depressed key determination reference data, but are determined to be correct inputs. That is, in this embodiment, erroneous inputs, which do not match the depressed key determination reference data, are deemed to be correct inputs until the number of the erroneous inputs exceeds a fixed number, thus permitting the erroneous inputs.

In this embodiment, the number of admissible characters is set at 5 with respect to the lyrics for one phrase. Accordingly, even if erroneous inputs equivalent to five characters are made by the time all the characters forming one phrase have been input, such erroneous inputs will not be counted in the number of errors, but in the event that a sixth character is erroneously input, this and subsequent inputs are counted in the number of errors.

Accordingly, in S54, it is determined whether or not the value of the admissible character counter S is the set numeric value “5” of the number of admissible characters or less. That is, if the value of the admissible character counter S is 5 or less (S54: YES), the process moves to S57. Conversely, if the value of the admissible character counter S is 6 or more (S54: NO), an erroneous input is treated as an input error, as the input result of which the determination result “MISS” is stored in the RAM 54. Then, at this point, “1” is also added to the number of errors stored in the RAM 54. After the determination result “MISS” is stored in the RAM 54 and “1” is added to the number of errors, the correctness determination process (S44) is brought to an end.

In this way, practically, even if keys depressed to make inputs have been mistaken, such inputs are deemed to be correct inputs until the number of the inputs reaches the specified number of admissible characters, so that even a beginner, who is not used to a typing game, can perform the typing game without worrying about errors.

Meanwhile, in S56, to which the process moves if it is determined in S52 that the depressed key is correct (S52: YES), the determination of key input timing correctness is performed. The key input timing correctness is determined by comparing the input time data, which is stored in the RAM 54, and the input timing determination reference data, which is included in the determination reference data. If the input timing specified by the input timing determination reference data matches a player's key input timing indicated by the input time data, it is determined that a key input has been made at a correct input timing (S56: YES), and the process moves to S57. Conversely, if the input timing specified by the input timing determination reference data does not match a player's key input timing (S56: NO), the input result “GOOD” is stored in the RAM 54.

After the input result “GOOD” is stored in the RAM 54, the correctness determination process (S44) is brought to an end.

Then, in S57, to which the process moves if a key input is wrong but the value of the admissible character counter S is 5 or less (S54: YES) or if a correct key input has been made and the input timing is also correct (S56: YES), “PERFECT” is stored in the RAM 54 (S57) as the determination result of the key input. After the determination result “PERFECT” is stored in the RAM 54, the correctness determination process (S44) is brought to an end.

After the character determination result is stored in the RAM 54 in the correctness determination process (S44) or S43, in S45, an input effect process, which is based on the depressed key correctness determination result, is performed (S45).

At this point, in this embodiment, as the input effect, the illumination effects by the keyboard 6, the illumination units 7, and the spotlights 11 are performed based on the determination result (“PERFECT”, “GOOD”, or “MISS”) stored in the RAM 54.

For example, when a typing game based on the song A is being executed, as shown in FIG. 16, an illumination effect, which differs depending on a key input determination result, is performed.

When a typing game is being executed based on the song A and the determination result “PERFECT” is stored in the RAM 54, as described above, the keyboard 6 performs the effect of illuminating a depressed key in “blue”, while the illumination units 7 perform the effect in which the whole illumination units 7 flash on and off in a single color (e.g., blue). That is, on the illumination units 7, all the 24 full color LEDs 11 arranged on the illumination units 7 flash on and off in a single color.

In the case of the determination result “GOOD”, as described above, on the keyboard 6, the effect of illuminating a depressed key in “yellow” is performed, while, on the illumination units 7, the illumination effect of presenting one emission ring is performed. On the spotlights 11, unlike the aforementioned case of “PERFECT”, an illumination effect, such as a variation in the light emitting mode, is not performed, but light is emitted in a normal state.

Meanwhile, in the case of the determination result “MISS”, the illumination effects by the illumination units 7 and the spotlights 11 are not performed, but only the illumination effect by the keyboard 6 is performed. At this point, as described above, when “MISS” is determined as a determination result, there are two kinds of case. That is, one case is that the predetermined time has elapsed without performing any key input, and the other is that the sixth or subsequent key input error is made in the case of six erroneous key inputs or more in one phrase.

When the predetermined time has elapsed without performing any key input, only the illumination effect is performed in which only a correct key with which an input should be made is illuminated in green. When the sixth or subsequent key input error is made in the case of six erroneous key inputs or more in one phrase, the illumination effect is performed in which a character input key 111 depressed is illuminated in red, while a correct key with which an input should be made is illuminated in green.

After the input effect process (S45) is thus performed based on the key input determination result, in S46, the score calculation process is performed based on the determination result of the correctness determination process (S44). In the score calculation process (S46), the addition of the player's score in the current game, which is stored in the RAM 54, is performed based on the determination result (“PERFECT”, “GOOD”, or “MISS”).

That is, when the determination result in the correctness determination process (S48) is “GOOD”, only a score, which is based on the fact that a correct key has been depressed, is added, while, in the case of the determination result “PERFECT”, as well as a score based on a correct key input, a score based on a key input at a correct timing is added.

Meanwhile, in the case of the determination result “MISS”, no score is added, and the score calculation process (S46) is brought to an end.

Thereafter, in S47, the variable m stored in the RAM 54 is read out, “+1” is added thereto, and the thus added variable m is stored again in the RAM 54. Subsequently, in S48, it is determined whether or not the value of the variable m has reached “n−1”, i.e., whether all the character input determinations as to the respective characters forming one phrase have ended or not.

If it is determined that the value of the variable m has not reached “n−1” (S48: NO), the process returns to S41 again to perform the input determination of the next character out of the respective characters which form one phrase.

Conversely, if it is determined that the value of the variable m has reached “n−1” (S48: YES), it follows that the input of the characters of one phrase has been completed, so that the process moves to S49.

In S49, the value of the admissible character counter S is initialized and returned to “0”. It follows thereby that five admissible characters are granted to the player. Accordingly, the player will be allowed to make input errors equivalent to five characters for each phrase, so that even a beginner who is not used to a typing game can play the game without worrying about errors, and can thus fully enjoy the typing game on the typing game apparatus 1.

As described so far, in the typing game apparatus 1 of this embodiment, even when the lyrics for one phrase, which are displayed in the lyrics display portion 22 and the roman letter display portion 23, have been input with different keys from keys to be input, even actually erroneous inputs are determined to be correct inputs up to the number of times specified in number-of-admissible-characters data. That is, even if keys, which differ from keys to be depressed based on the lyrics displayed in the lyrics display portion 22 and the roman letter display portion 23, have been depressed up to five times in one phrase of certain lyrics, such keys are deemed to have been depressed in accordance with the lyrics.

Accordingly, even a typing game beginner is allowed to make up to five erroneous key inputs per phrase, and can thus enjoy a typing game without worrying about erroneous inputs.

Furthermore, when the number of errors has reached a predetermined value or greater, a song used in a typing game is brought to an end without playing all its stages. In this embodiment, however, if the number of erroneous input operations in one phrase is five or less, the input operations are deemed to be correct inputs, so that even a typing game beginner can enjoy all the stages of the song.

Also, in this embodiment, the effect contents of the effect process (S45) differ based on the determination result of the correctness determination process (S44). In this case as well, if the number of erroneous input operations in one phrase is five or less, the determination result “PERFECT” is stored in the RAM 54, so that the input effect based on the determination result “PERFECT” is performed. Accordingly, this leads to the execution of the input effect based on the determination result “PERFECT” which is not executed if correct keys are not depressed at correct timings, so that even a typing game beginner can enjoy the entertainment related to the input effect.

The invention is not limited to the aforementioned embodiment, but various modifications are possible without departing from the scope of the invention.

For example, in this embodiment, the number-of-admissible-characters data specifies “five characters per phrase”, but the invention is not limited to this embodiment. For example, it may specify the number of admissible characters per song (e.g., the number of admissible characters per song (three stages in total) is 80). Besides, it may specify the number of admissible characters per stage (e.g., the number of admissible characters per stage is 20).

Also, in this embodiment, the correctness determination is performed for each character, but may be performed on a word to word basis, or may be performed on a phrase to phrase basis.

Furthermore, in this embodiment, the process is performed based on one kind of number-of-admissible-characters data stored in the ROM 53. However, the configuration may be such that a plurality of kinds of number-of-admissible-characters data are stored in the ROM 53, and such that one kind of number-of-admissible-characters data can be selected and set out of the plurality of kinds of number-of-admissible-characters data. In this case, the player can select the number of admissible characters in response to a skill related to a typing game, and can thus further enjoy the entertainment related to the typing game.

Also, in this embodiment, the illumination effects by the keyboard 6, the illumination units 7, and the spotlights 11 are performed as the combo effect and the input effect, but the invention is not limited to this embodiment. Alternatively, in addition to these illumination effects, effects based on the display contents of the first and second liquid crystal displays 3 and 4 may be performed. This makes it possible to further enjoy the entertainment related to a difference in effects which can be obtained by the configuration in which erroneous input operations have been made but are deemed to be correct key inputs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A typing game apparatus comprising:
a display which displays a character;
an input device having arranged thereon a plurality of keys corresponding to a plurality of the characters;
a storing device which stores determination reference data for use in determining the correctness of the result of an input from the input device;
a correctness determination module which determines the correctness of a key input based on the result of the input from the input device and the determination reference data;
a game controller which proceeds with a typing game based on the determination result of the correctness determination module;
a number-of-erroneous-inputs counter which, when inputs have been made with different keys from the ones indicated by characters displayed on the display, counts the number of the inputs as erroneous input operations; and
an admissible character determination module which, when the result of the count by the number-of-erroneous-inputs counter satisfies an admissibility condition that erroneous key inputs be deemed correct, determines the erroneous input operations to be correct key inputs as their input result.

2. A typing game apparatus according to claim 1, wherein
the admissibility condition is a condition which, when erroneous input operations have been performed in which inputs are made with different keys from the ones indicated by characters displayed on the display, specifies the number of the inputs which are deemed to be correct key inputs.

3. A typing game apparatus according to claim 1, wherein
the storing device stores song data related to a song,
the determination reference data includes input determination reference data, which is used to determine the correctness of key inputs which are based on lyrics of the song, and timing determination reference data, which is used to determine the correctness of the timing of the key inputs, and
the game controller proceeds with the typing game based on the song data.
